(19) United States
(12) Patent Application Publication
(10) Pub. No.: US 2010/0147811 A1
(43) Pub. Date: Jun. 17, 2010

(54) APPARATUS FOR LASER SCRIBING OF DIELECTRIC-COATED SEMICONDUCTOR WAFERS

(76) Inventor: Mark S. Sobey, San Carlos, CA (US)

Correspondence Address: Coherent, Inc. c/o Morrison & Forester, 425 Market Street, San Francisco, CA, 94105-2482, US

(21) Appl. No.: 12/348,727

(22) Filed: Jan. 5, 2009

Related U.S. Application Data
(60) Provisional application No. 61/121,600, filed on Dec. 11, 2008.

(51) Int. Cl. B23K 26/067; B23K 26/08; B23K 26/36

(52) U.S. Cl. 219/121.69; 219/121.68; 219/121.76

(57) ABSTRACT

A groove pattern is scribed into a silicon-nitride layer on a silicon wafer using four independently scanned, focused beams of laser radiation. Each focused beam is scannable within one of four scan-field positions on a turntable. The wafer is transported incrementally from the first scan-field position to the second, third and fourth scan-field positions. The scanned focused laser beam in each scan-field position scribes a portion of the groove pattern on the wafer, with scribing of the groove pattern being completed at the fourth scan-field position.

### PRIORITY

This application claims priority to U.S. Provisional Application Ser. No. 61/121,600, field Dec. 11, 2008, the disclosure of which is incorporated herein by reference.

### TECHNICAL FIELD OF THE INVENTION

The present invention relates in general to apparatus for laser scribing (selective removal) of dielectric layers on semiconductor wafers. The invention relates in particular to apparatus for scribing a pattern of grooves in a silicon nitride antireflection layer on silicon solar-cells.

### DISCUSSION OF BACKGROUND ART

One preferred solar-cell configuration includes a p-doped substrate of single crystal or polycrystalline silicon (Si) surmounted by a thinner n-doped layer for providing a p-n junction. The n-doped layer is surmounted by a passivating and antireflection reflecting layer of silicon nitride (SiNₓ), typically having a thickness between about 70 and 120 nanometers (nm). The symbol SiNₓ as used herein to represent silicon nitride indicates that the silicon nitride may not be stoichiometric silicon nitride (Si₃N₄) but may have excess silicon depending on the deposition process and conditions.

A pattern of metal contacts (top contacts) is formed on the top layer, the contacts extending through the SiNₓ layer to make contact with the n-doped Si layer. One preferred contact-pattern includes a plurality of metal “fingers” or collectors spaced-apart and parallel to each other. The collectors make contact to two bus-bar contacts spaced apart and parallel to each other perpendicular to the collector contacts. A metal contact is deposited on the reverse side of the substrate to form the base contact.

One typical process for providing the top contacts is to deposit a metal paste on the SiN layer in the contact pattern, using a silk-screen process, and then heat the paste-coated cell to a temperature of about 600° C., for several hours. During the heating process, the metal paste sinters and penetrates the SiNₓ layer to form contacts with the n-doped Si layer.

One disadvantage of this contact-forming method is the time required for the sintering process. Another disadvantage is that a limited resolution of the silk screen process provides that the finger or collector contacts are thicker than ideal inasmuch as the total area of all contacts “shades” the cell from incident solar radiation and detracts from efficiency of the cell.

One possible approach for creating the top contacts on a solar-cell is to scan focused beam from a pulsed laser over the cell to ablate channels in SiNₓ. These channels can then be metallized. This method overcomes both the time and resolution disadvantages of the above-described silk screen process.

Experimental scans using the latter approach have been performed wherein a beam of 355-nm pulses from a frequency-tripled mode-locked Nd:YVO₄ laser were focused into a spot having a Gaussian intensity distribution and a beam diameter of about 13 μm. The beam had a focal depth of about 400 μm. Single-pass scanning was employed to form finger-grooves with a 1-mm line-separation between the grooves. The grooves had a width of about 10 μm. Busbars were formed by multiple parallel scans of the beam with a 50-μm separation of multiple parallel scans to form busbar grooves. The pulse duration of the mode-locked pulses was about 10 picoseconds (ps) and the pulses were delivered at a pulse-repetition frequency of about 80 MHz. The time-averaged power in the mode-locked beam was about 8 watts (W). With these beam parameters it was possible to form (scribe) finger grooves at a linear speed of about 2 meters per second (m/s).

Clearly, with a more powerful laser higher scribing speeds may be possible. The cost of increasing the power of lasers, however, increases more than linearly with the increase in power. Further, for a frequency-tripled laser delivering UV radiation, there may be some upper limit to output-power based on the capacity of an optically nonlinear crystal used for the frequency tripling to tolerate the power. Increasing scribing speed is simply one means for providing higher solar-cell throughput. It would be useful if this throughput could be increased without a need for a laser of significantly higher power than the laser used in the above-described experimental scans.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates one preferred groove pattern for the solar-cell layer structure of FIG. 1 including fine individual grooves spaced apart and parallel to each other and two wider close-spaced clusters of grooves spaced apart and parallel to each other and perpendicular to the fine grooves.

FIG. 2 schematically illustrates one preferred embodiment of apparatus in accordance with the present invention for selective removal (scribing) of silicon-nitride from silicon in a predetermined pattern, the apparatus including a turntable with four scanning positions, two lasers each delivering a laser beam with each laser beam being divided into two beams to provide four laser beams, with the four laser beams being delivered to four scan-heads corresponding to the four scan positions and arranged to scan the beam within a scan-field, the apparatus being arranged such that elements of the predetermined pattern are scribed at each of the scan positions with the scribing pattern being initiated at the first position and completed at the fourth position.

FIG. 3 schematically illustrates another preferred embodiment of apparatus in accordance with the present invention for selective removal (scribing) of silicon-nitride from silicon in a predetermined pattern, similar to the apparatus of FIG. 2, but wherein there are four lasers providing the four laser beams.

FIG. 4 schematically illustrates yet another preferred embodiment of apparatus in accordance with the present invention for selective removal (scribing) of silicon-nitride from silicon in a predetermined pattern, similar to the apparatus of FIG. 3, but wherein one-quarter of the predetermined pattern is scribed at each of the four positions and the scan-heads are aligned with the scan positions such that the same central portion of the scan-field is used for scribing in each position.

### DETAILED DESCRIPTION OF THE INVENTION

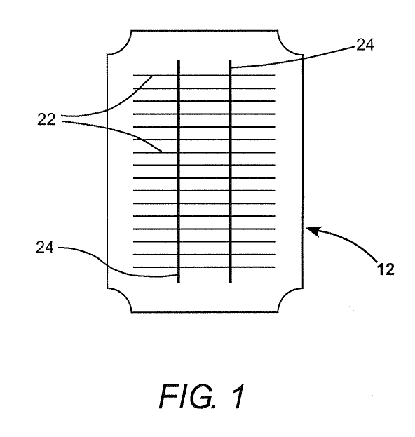

Referring now to the drawings, wherein like components are designated by like reference numerals, FIG. 1 schematically illustrates one pattern of contacts for a solar-cell 12 for which selective removal of silicon nitride is required to form a corresponding groove pattern for metallization, as discussed above. The pattern includes fine grooves 22 spaced apart and parallel to each other corresponding to the finger or collector electrodes, and two wider close-spaced clusters of grooves 24 spaced apart and parallel to each other and perpendicular to the fine grooves. Grooves 24 correspond to the bus-bar electrodes.

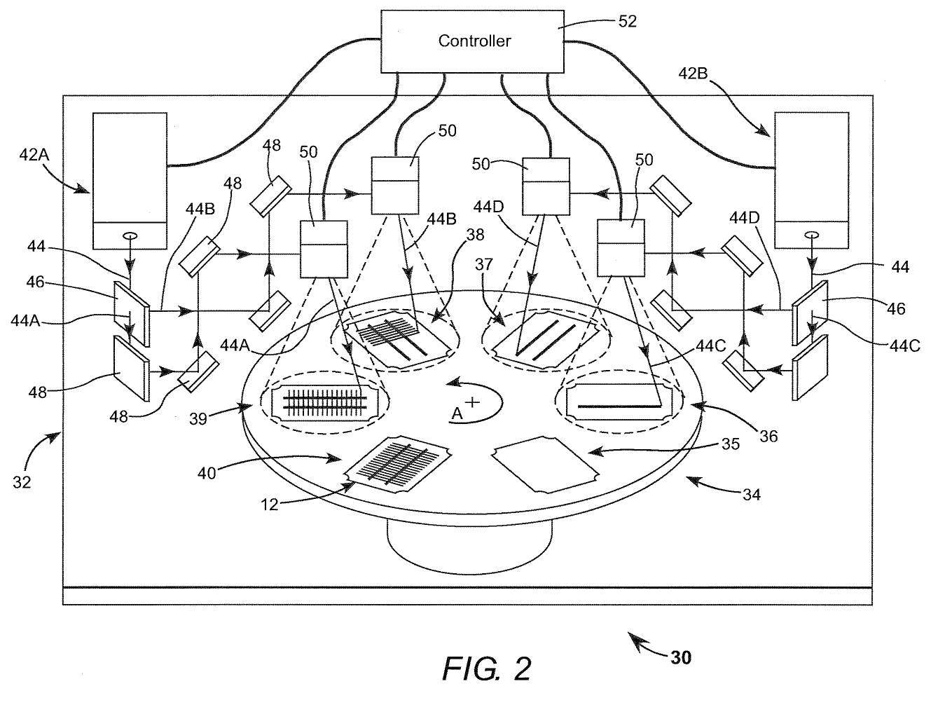

FIG. 2 schematically illustrates one preferred embodiment 30 of apparatus in accordance with the present invention for carrying out the nitride removal. Apparatus 30 is assembled on a rigid base 32, for example, a granite slab. A turntable 34, incrementally rotatable, as indicted by arrow A, is provided for supporting solar-cells 12, which are to be processed. There are six positions 35, 36, 37, 38, 39, and 40 over the turntable on which the solar-cells can be supported. Preferably, the wafers are held on the turntable by means of vacuum chucks (not shown).

Two lasers 42A and 42B are mounted on the turntable, each thereof emitting a laser-beam 44. Different kinds of lasers with wavelengths from UV to IR, in pulsed and CW operation, have been proposed in the prior-art for ablation of insulators on solar-cells. Apparatus 30 is applicable to any of these lasers.

Laser beam 44 from laser 42A is divided by a beamsplitter 46 into two beams 44A and 44B. Laser beam 44 from laser 42B is divided by another beamsplitter 46 into two beams 44C and 44D. Each of the beams 44A-C is directed to a dedicated one of four scan-heads 50 by turning-mirrors 48. The scan-heads are located above turntable 32 each aligned with one of the solar-cell processing positions 36, 37, 38, and 39 over the turntable. In practice, the scan-heads can be supported on a platform over the turntable, with the platform supported on pillars on the base 32. The platform and pillars are not shown in FIG. 2, for convenience of illustration.

Each scan-head 50 includes a two-axis galvanometer scanner (not shown) for scanning the beam delivered thereto and an f-theta focusing-lens (also not shown) for focusing the scanned beam on a solar-cell. An f-theta lens is a lens designed to receive a beam scanned by the galvanometer scanner and focus the beam in a flat field whatever the scan angle of a beam on the lens. The flat field is indicated in FIG. 2 as bounded by dashed circles (appearing as ellipses because of the view angle). F-theta lenses are commercially available from several sources, as are galvanometer scanners. The galvanometer scanners in the scan-heads are independently operable by a controller 52 which is also arranged to independently control the power in the beam emitted by each of lasers 42A and 42B.

In one method of operating apparatus depicted in FIG. 2, a solar-cell to be laser scribed (as depicted in FIG. 1) is loaded onto the turntable in position 35. The turntable is then incrementally rotated such that the loaded solar-cell is indexed into position 36, and laser beam 44C is scanned in a manner such that a busbar groove 24 (see FIG. 1) is scribed on the cell. This will typically involve a number over overlapping parallel scans of the beam. A second solar-cell to be scribed is placed in loading position 35.

The turntable is then incrementally rotated such that the solar-cell in position 36 is indexed to position 37 and the second-loaded solar-cell in position 35 is indexed to position 36. One busbar groove is scribed on the newly-loaded solar-cell by beam 44D while a second busbar groove 24 is added to the first-loaded cell by scanning beam 44C. A third solar-cell is loaded into position 35

The turntable is then incrementally rotated such that the solar-cell in position 37 is indexed to position 38, the solar-cell in position 36 is indexed to position 37, and the third-loaded cell is indexed into position 36. Half of finger or collector grooves 22 (see FIG. 1) are scribed into the first loaded solar-cell by beam 44B, while a second busbar groove 24 is added to the second-loaded solar-cell by beam 44C, and a first busbar groove 24 is scribed on the third-loaded solar-cell by beam 44D. A fourth solar-cell is loaded into position 35.

The turntable is again incrementally rotated such that the solar-cell in position 38 is indexed to position 39, the solar-cell in position 37 is indexed to position 38, the solar-cell in position 36 is indexed into position 37, and the fourth-loaded cell is indexed into position 36. The remaining half of the finger-grooves 22 are scribed into the first-loaded solar-cell by beam 44A, half of finger-grooves 22 are scribed into the second loaded solar-cell by beam 44B, a second busbar groove 24 is added to the third-loaded solar-cell by beam 44C, and a first busbar groove 24 is scribed on the fourth-loaded solar-cell by beam 44D. A fifth solar-cell is loaded into position 35.

The turntable is yet again incrementally rotated such that the solar-cell in position 39 is indexed to position 40, the solar-cell in position 38 is indexed to position 39, the solar-cell in position 37 is indexed into position 38, the solar-cell in position 36 is indexed into position 37, and the fifth-loaded cell is indexed into position 36. The remaining half of the finger-grooves 22 are scribed into the second-loaded solar-cell by 44A, half of finger-grooves 22 are scribed into the third loaded solar-cell by beam 44B, a second busbar groove 24 is added to the fourth-loaded solar-cell by beam 44C, and a first busbar groove 24 is scribed on the fifth-loaded solar-cell by beam 44D. A sixth solar-cell is loaded into position 35 and the completely scribed, first-loaded solar-cell is removed unloaded from position 40.

With continued incremental rotating of turntable, solar-cells can continue to be loaded at loading-position 36, while completely scribed solar-cells are unloaded from position 40, and while scribing operations are performed simultaneously on solar-cells in positions 36, 37, 38, and 39, by beams 44D, 44C, 44B, and 44A, respectively. This provides that the throughput through apparatus 30 of completely scribed cells can be up to four-times what the throughput would be if a solar-cell were completely scribed by only one scanned laser beam having a power the same as any one of the beams 44A-D.

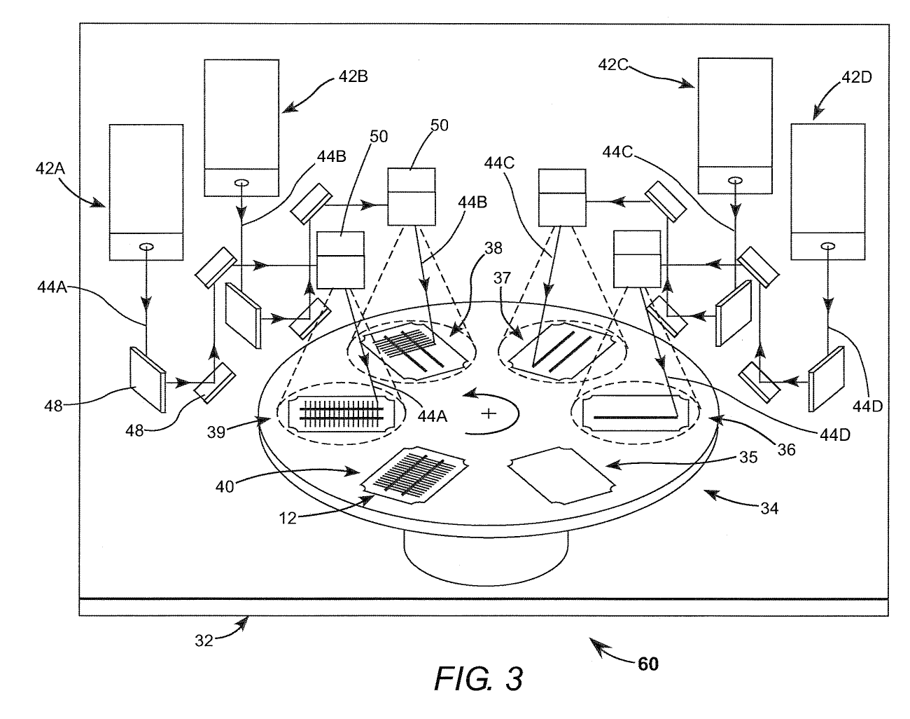

FIG. 3 schematically illustrates another preferred embodiment 60 of apparatus in accordance with the present invention. Apparatus 60 is similar to apparatus 30 of FIG. 2 with an exception that beams 44A, 44B, 44C, and 44D are provided by lasers 42A, 42B, 42C, and 42D, respectively. The apparatus can be operated as described above with reference to apparatus 30.

The method of operation described above, whether applied to apparatus 30 or to apparatus 60, can require that most of the scan-field of any of the scan-heads be used to perform a portion of the complete scribing. The more of the scan-field that is required the greater will become the possibility of scribing problems due to any deviation of the scan-field from absolutely flat.

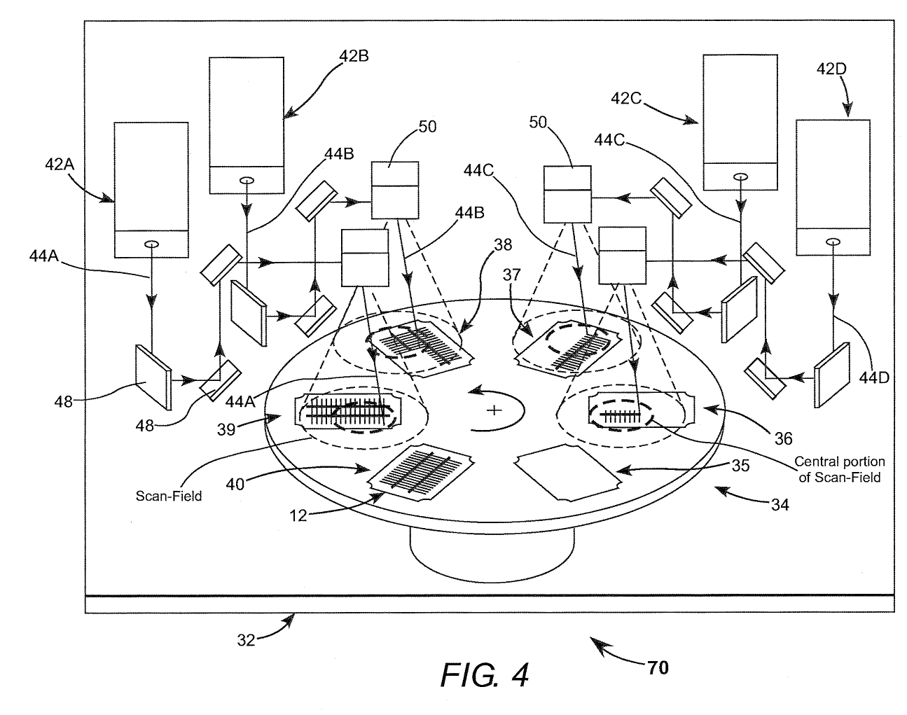

FIG. 4 schematically illustrates yet another embodiment 70 of apparatus in accordance with the present invention wherein a complete scribe pattern is made by sequentially scribing four equal fractions or quadrants of the total area of the pattern using four laser beams. Apparatus 70 is similar to apparatus 60 of FIG. 3 with an exception that scan-heads 50 are aligned with respect to the scribing positions such that only a central fraction of the scan-field, designated by bold dashed circles (appearing as ellipses), is used in each scribing operation.

Continuing with reference to FIG. 4, and with reference in addition to FIG. 1, each fraction (quarter) of the scribe pattern, here, comprises one half (lengthwise) of one busbar groove 24 and one-half (lengthwise) of one-half of the number of finger grooves 22 as indicated on the solar-cell in position 36 on turntable 34. In position 37, the remaining length of the busbar groove is added together with one-half (lengthwise) of the remaining half of the number of the finger grooves. In position 38 one half (lengthwise) of the other busbar groove 24 and the remaining one-half (lengthwise) of one-half of the number of finger grooves 22 is added. In position 39 the remaining one-half (lengthwise) of the other busbar groove 24 and one-half (lengthwise) of the remaining one-half of the number of finger grooves 22 is added to complete the scribe pattern. This procedure of forming a complete image or patter from fractions thereof is often referred to as “tiling” or “stitching” by practitioners of the art. Clearly the scribing method depicted in FIG.4 could also be carried out in the apparatus of FIGS. 2 and 3, if scan-field flatness were not of concern.

Each of the above described embodiments of the present invention has an advantage that the apparatus enables a high unit (solar-cell wafer) throughput by dividing the total wafer processing (laser scribing) time (X) into a plurality (n) of processing sequences performed in n positions on the turntable, where n can be 2 or greater. Preferably there is also one load and one unload position (2 total) as described. However a single position can be used for both loading and unloading. The time (T) for processing each sequential wafer (once the turntable is fully loaded) will be equal to (X/n)+Y, where Y is the time to rotate from one position to the next one in the sequence.

Clearly the invention is more advantageous the larger X (the process time) is compared to Y (the step time). By way of example, in above described preferred embodiments where n=4, X=12 seconds, and Y=1 second, the sequential time to produce a wafer is (12/4)+1=4s or approx ⅓ of the total wafer process time. Increasing the number of processing positions yield diminishing decreases in processing time as the step time (Y) becomes more significant. Doubling the number of processing positions from 4 to 8 reduces the sequential processing time from 4 seconds to 2.5 seconds, i.e., by less than a factor of two.

It is also possible to use of one or more of turntable positions to perform another function such as inspection. The throughput time per wafer is still linked to the division of the process steps, provided that the inspection (additional function) time L is less than X/n (L<X/n). If the inspection time were greater than X/n and every wafer had to be inspected, then a new unit would be available every L+Y seconds, i.e., L would be the limiting factor not X/n.

It should be noted here that while the present invention is described in the context of scribing through a silicon nitride layer on single-crystal or polycrystalline silicon, the invention is not limited to scribing silicon nitride. The method is also applicable to scribing other dielectric materials that can be deposited on crystalline silicon or another semiconductor material for passivation, insulation, or anti-reflection purposes. By way of example, one material commonly deposited for passivation purposes is silicon dioxide (SiO₂). The semiconductor material may also be in the form of a layer supported on a substrate.

In summary, the method of the present invention is described above in terms of a preferred and other embodiments. The invention is not limited, however, to the embodiments described and depicted. Rather, the invention is defined by the claims appended hereto.

What is claimed is:

1. Apparatus for scribing a pattern of grooves through a layer of dielectric material deposited on a semiconductor material, comprising:
a turntable for supporting the material to be scribed;
a plurality of laser beams provided by at least one laser;
an arrangement for focusing and independently scanning each of the laser beams over a corresponding plurality of scan-field positions located around the turntable, the scan-field positions being located over the turntable such that when the material is supported on the turntable the material can be transported sequentially into each of the scan-field positions from a first of the scan-field positions to a last of the scan-field positions by incrementally rotating the turntable; and
wherein the scanned focused laser beam in each of the scan-field positions is controllable to scribe a different portion of the groove pattern on the material, with a first portion of the pattern being scribed in the first scan-field position and a final portion of the pattern being scribed at the last scan-field position to complete the groove pattern.

2. The apparatus of claim 1, wherein there are N lasers, the output of each of which is optically divided into two portions thereby providing 2N laser beams.

3. The apparatus of claim 2, wherein N=2 and there four laser beams each thereof delivered to a corresponding one of four scan-field positions.

4. The apparatus of claim 1, wherein there are N lasers each providing one of the laser beams.

5. The apparatus of claim 1, wherein the scan-field positions are distributed around the turntable such that material to be scribed can be loaded onto the turntable in a loading position outside of the scan-field positions and transported into the first scan-field position by an incremental rotation of the turntable.

6. The apparatus of claim 4, wherein the scan-field positions are distributed around the turntable such that completely scribed material in the final scan-field position can be transported to an unloading position between the final scan-field position and the loading position by an incremental rotation of the turntable.

7. The apparatus of claim 1, wherein the groove pattern includes a plurality of grooves and different one or more of the grooves are scribed at each of the scan-field positions.

8. The apparatus of claim 1, wherein a different portion of the grooves is scribed at each of the scan-field positions.

9. The apparatus of claim 8, wherein the scan-field positions are arranged with respect to the turntable such that the portion of the groove-pattern being scribed in each of the scan-field positions is about centrally located in the scan-field.

10. The apparatus of claim 1, wherein the semiconductor material is in the form of a crystalline wafer.

11. The apparatus of claim 1, wherein the semiconductor material is in the form of a layer supported on a substrate.

12. Apparatus for scribing a pattern of grooves through a layer of a dielectric material deposited on a silicon wafer, comprising:
a turntable for supporting the wafer to be scribed;
an arrangement for providing four beams of laser radiation;
an arrangement for focusing and independently scanning each of the laser-radiation beams over corresponding one of four scan-field positions located around the turntable, the scan-field positions being located over the turntable such that when the wafer is supported on the turntable the wafer can be transported sequentially into each of the scan-field positions from the first of the scan-field positions to a fourth of the scan-field positions by incrementally rotating the turntable; and
wherein the scanned focused laser beam in each of the scan-field position is controllable to scribe a different portion of the groove pattern on the wafer, with a first portion of the pattern being scribed in the first scan-field position and a final portion of the pattern being scribed at the fourth scan-field position to complete the groove pattern.

13. The apparatus of claim 12, wherein the dielectric material is silicon nitride.

14. The apparatus of claim 12, wherein the scan-field positions are distributed around the turntable such that material to be scribed can be loaded onto the turntable in a loading position outside of the scan-field positions and transported into the first scan-field position by an incremental rotation of the turntable.

15. The apparatus of claim 14, wherein the scan-field positions are distributed around the turntable such that completely scribed material in the fourth scan-field position can be transported to an unloading position between the fourth scan-field position and the loading position by an incremental rotation of the turntable.

16. A method of scribing a wafer with a pattern comprising the steps of:
(a) providing a rotatable turntable with at least five positions for holding a wafer, with at least one of said positions for loading or unloading a wafer and the remaining four positions used for a scribing step;
(b) laser scribing a portion of the pattern in each of four wafers located in the four positions;
(c) loading an unscribed wafer onto the turntable;
(d) rotating the turntable to index the wafers;
(e) unloading a fully scribed wafer from the turntable;
(f) laser scribing a portion of the pattern in each wafer in the four positions; and
(g) repeating steps (c), (d), (e) and (f) until a complete pattern is formed on each wafer.

17. A method as recited in claim 16, wherein the laser scribing is performed with a laser beam and wherein there are four lasers generating four laser beams for each of the four positions where the scribing step occurs.

18. A method as recited in claim 16, wherein the laser scribing is performed with a laser beam and wherein there are two lasers generating two laser beams, and wherein said two laser beams are each split to create four laser beams, one for each of the four positions where the scribing step occurs.

19. A method as recited in claim 16, wherein the turntable includes one position for loading unscribed wafers and a second position of unloading scribed wafers.

20. A method as recited in claim 16, wherein the pattern consists of a plurality of grooves and a different portion of the grooves is scribed at each of the four positions.
